(19) United States
(12) Patent Application Publication
(10) Pub. No.: US 2025/0189755 A1
(43) Pub. Date: Jun. 12, 2025

(54) LENS UNIT, LENS BARREL, AND ADJUSTMENT METHOD

(71) Applicant: CANON KABUSHIKI KAISHA, Tokyo (JP)

(72) Inventor: MASAMI YOSHIDA, Kanagawa (JP)

(21) Appl. No.: 18/971,982

(22) Filed: Dec. 6, 2024

(30) Foreign Application Priority Data
Dec. 7, 2023 (JP) 2023-207118

(51) Int. Cl. G02B 7/10; G02B 7/02; G03B 17/12

(52) U.S. Cl. CPC G02B 7/10; G02B 7/021; G03B 17/12

(57) ABSTRACT

A lens unit that includes a plurality of lenses includes a holding frame configured to hold a first lens of the plurality of lenses, a first adjustment frame configured to hold a first adjustment lens of the plurality of lenses and adjust the first adjustment lens in a direction orthogonal to an optical axis with respect to the holding frame, and a second adjustment frame configured to hold a second adjustment lens of the plurality of lenses and adjust the second adjustment lens in the direction orthogonal to the optical axis with respect to the holding frame, wherein the first adjustment frame and the second adjustment frame are arranged on an object side in an optical axis direction with respect to the holding frame.

### FIELD

The present disclosure relates to a lens unit and the like. Particularly, the present disclosure relates to a lens unit and the like, which are used in an imaging apparatus.

### DESCRIPTION OF THE RELATED ART

Currently, network cameras, i.e., surveillance cameras, are installed in various places such as cities and factories. In recent years, surveillance cameras have been required to have high optical performance by an increase in the number of pixels and size reduction. In order to achieve high optical performance, eccentricity adjustment is performed in some cases to correct variations in lenses and positional deviations between lenses, which occur during manufacturing processes.

According to Japanese Patent Application Laid-Open No. 2004-219608, a technique for performing eccentricity adjustment on a lens is discussed. Specifically, according to Japanese Patent Application Laid-Open No. 2004-219608, a plurality of lens holding frames in a housing is moved in a direction orthogonal to an optical axis of lenses to perform eccentricity adjustment and is fixed using pressing rings. However, according to the technique discussed in Japanese Patent Application Laid-Open No. 2004-219608, the lens holding frame to be adjusted is placed on an image side in an optical axis direction with respect to the lens holding frame that holds a reference lens. Various components are arranged on the image side in the optical axis direction. Thus, an adjustment mechanism that adjusts the lens holding frames and various components are arranged close to each other, and it is necessary to provide space to prevent them from interfering with each other, which may result in an increase in a size of an entire apparatus.

### SUMMARY

The present disclosure addresses improving optical performance without increasing the size of an apparatus.

According to an aspect of the present disclosure, a lens unit that includes a plurality of lenses includes a holding frame configured to hold a first lens of the plurality of lenses, a first adjustment frame configured to hold a first adjustment lens in the plurality of lenses and adjust the first adjustment lens of a direction orthogonal to an optical axis with respect to the holding frame, and a second adjustment frame configured to hold a second adjustment lens of the plurality of lenses and adjust the second adjustment lens in the direction orthogonal to the optical axis with respect to the holding frame, wherein the first adjustment frame and the second adjustment frame are arranged on an object side in an optical axis direction with respect to the holding frame.

Further features of the present disclosure will become apparent from the following description of exemplary embodiments with reference to the attached drawings.

### BRIEF DESCRIPTION OF THE DRAWINGS

FIG. 1 is a perspective view of an imaging apparatus according to an exemplary embodiment.

FIG. 2 is an exploded perspective view of the imaging apparatus according to the present exemplary embodiment.

FIG. 3 is an exploded perspective view of a second lens unit according to the present exemplary embodiment.

FIG. 4 is a cross-sectional view of the second lens unit according to the present exemplary embodiment.

FIG. 5 is a perspective view illustrating a state in which eccentricity adjustment is performed on a first adjustment lens.

FIG. 6 is a cross-sectional view of the second lens unit according to the present exemplary embodiment.

FIG. 7 is a perspective view illustrating a state in which eccentricity adjustment is performed on a second adjustment lens.

FIG. 8 is a perspective view illustrating a configuration of a second lens unit according to a first modification.

FIG. 9 is a cross-sectional perspective view illustrating a configuration of a second lens unit according to a second modification.

FIG. 10 is a cross-sectional perspective view illustrating a configuration of a second lens unit according to a third modification.

### DESCRIPTION OF THE EMBODIMENTS

Various exemplary embodiments of the present disclosure will be described in detail below with reference to the attached drawings.

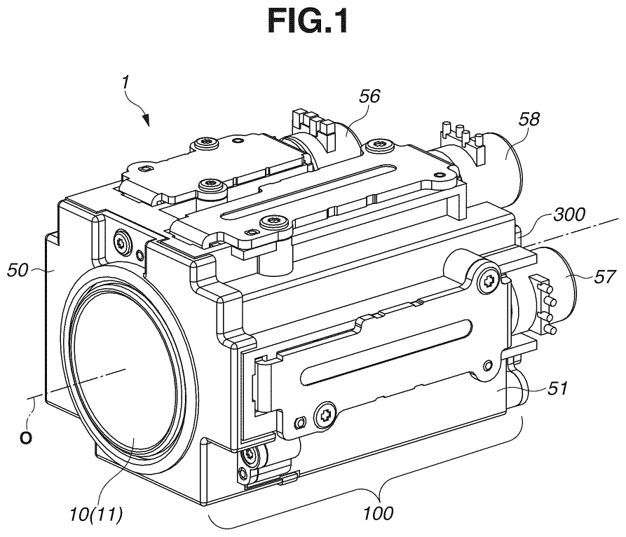

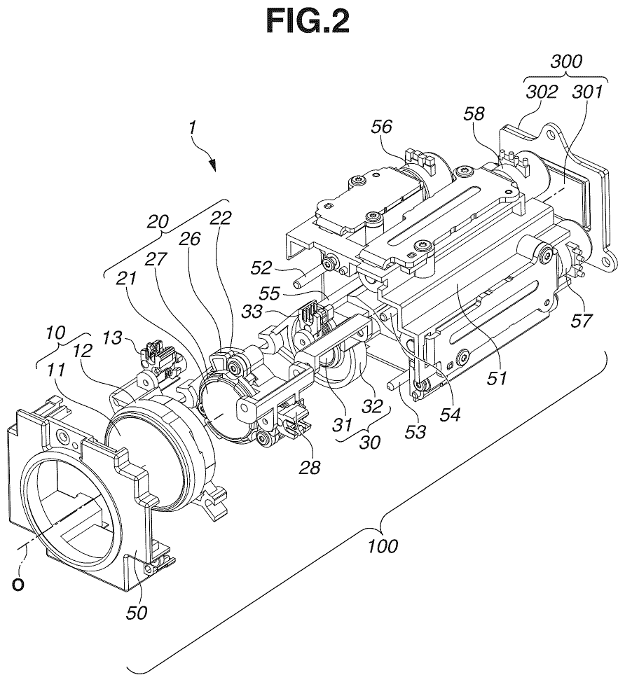

FIG. 1 is a perspective view of an imaging apparatus 1. In each of the drawings including FIG. 1, an alternate long and short dash line indicates an optical axis O of the imaging apparatus 1. In an optical axis direction, a side of a first lens unit 10, which is described below, is referred to as an object side (or a front side) and a side of an imaging element unit 300, which is described below, is referred to as an image side (or a rear side). FIG. 2 is an exploded perspective view of the imaging apparatus 1.

The imaging apparatus 1 includes a lens barrel 100 and the imaging element unit 300.

The lens barrel 100 according to the present exemplary embodiment includes three lens units. Specifically, the lens barrel 100 includes a front side housing member 50, a rear side housing member 51, and an imaging optical system including the first lens unit 10, a second lens unit 20, and a third lens unit 30.

The first lens unit 10 (first group lens unit) includes a first lens group 11 and a first lens holding frame 12. The first lens group 11 is held by the first lens holding frame 12.

The first lens holding frame 12 is engaged with a shaft-like guide bar 52 and is supported to be movable in the optical axis direction. The first lens holding frame 12 is also engaged with a shaft-like guide bar 53 and is restricted from rotating around the guide bar 52. Further, the first lens holding frame 12 rotatably holds a first group rack 13. The first group rack 13 is engaged with a lead screw portion of a first group drive unit 56 that includes an actuator of a stepping motor or the like. Thus, if the lead screw portion of the first group drive unit 56 rotates, the first lens holding frame 12 moves in the optical axis direction together with the first group rack 13.

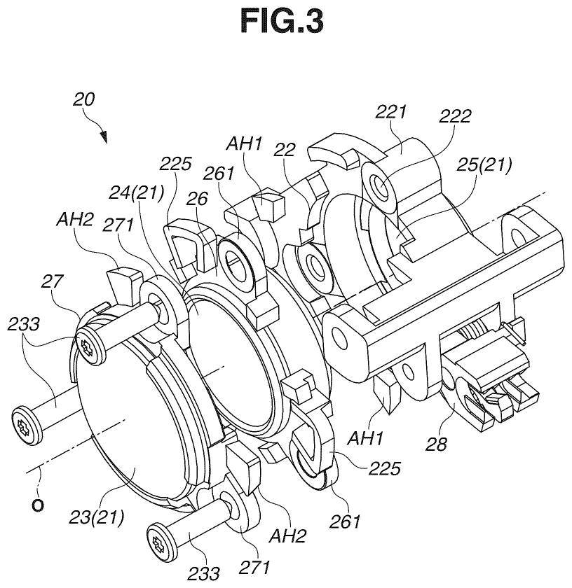

FIG. 3 is an exploded perspective view of the second lens unit 20 (an optical adjustment group).

The second lens unit 20 includes a second lens group 21. The second lens group 21 is a zoom lens group including a plurality of lenses. Specifically, the second lens group 21 includes a reference lens 25, a first adjustment lens 24, and a second adjustment lens 23.

The reference lens 25 is held by a second lens holding frame 22.

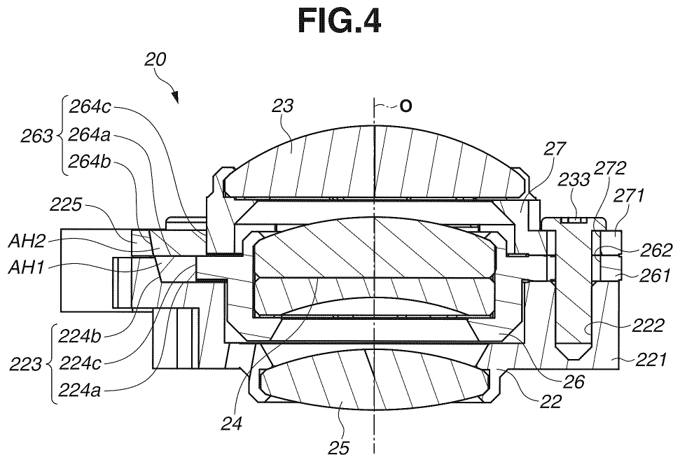

The first adjustment lens 24 includes two lenses (see FIG. 4 described below) and is held by a first adjustment frame 26. The first adjustment frame 26 is held by the second lens holding frame 22. The first adjustment frame 26 is located on the object side in the optical axis direction with respect to the second lens holding frame 22. Further, the first adjustment frame 26 can be adjusted in a direction orthogonal to the optical axis with respect to the second lens holding frame 22.

The second adjustment lens 23 is held by a second adjustment frame 27. The second adjustment frame 27 is held by the second lens holding frame 22 via the first adjustment frame 26. The second adjustment frame 27 is located on the object side in the optical axis direction with respect to the second lens holding frame 22 and the first adjustment frame 26. Further, the second adjustment frame 27 can be adjusted in the direction orthogonal to the optical axis with respect to the second lens holding frame 22.

In the second lens unit 20, the second lens holding frame 22, the first adjustment frame 26, and the second adjustment frame 27 are arranged in this order from the image side in the optical axis direction.

Here, a holding method for the second adjustment lens 23, the first adjustment lens 24, and the reference lens 25 is thermal caulking, but other holding methods such as adhesive fixing and pressure fixing using a pressing member may also be used and are not limited. Further, the second adjustment lens 23, the first adjustment lens 24, and the reference lens 25 may each be one or more lenses, and a lens configuration is not limited.

The second lens holding frame 22 is engaged with a shaft-like guide bar 54 and is supported to be movable in the optical axis direction. The second lens holding frame 22 is also engaged with a shaft-like guide bar 55 and is restricted from rotating around the guide bar 54. Further, the second lens holding frame 22 rotatably holds a second group rack 28. The second group rack 28 is engaged with a lead screw portion of a second group drive unit 57 that includes an actuator of a stepping motor or the like. Thus, if the lead screw portion is rotated by the second group drive unit 57, the second lens holding frame 22 moves in the optical axis direction together with the second group rack 28.

The present exemplary embodiment is not limited to a case where the second lens holding frame 22 holds the second group rack 28 and may include a configuration in which the first adjustment frame 26 or the second adjustment frame 27 holds the second group rack 28 and is engaged with the guide bars 54 and 55.

Detailed configurations of the second lens holding frame 22, the first adjustment frame 26, and the second adjustment frame 27, and an optical adjustment mechanism using these frames are described below.

The third lens unit 30 includes a third lens group 31 and a third lens holding frame 32.

The third lens group 31 is held by the third lens holding frame 32. The third lens holding frame 32 is engaged with the shaft-like guide bar 54 and is supported to be movable in the optical axis direction. The third lens holding frame 32 is also engaged with the shaft-like guide bar 55 and is restricted from rotating around the guide bar 54. Further, the third lens holding frame 32 rotatably holds a third group rack 33. The third group rack 33 is engaged with a lead screw portion of a third group drive unit 58 that includes an actuator of a stepping motor or the like. Thus, if the lead screw portion is rotated by the third group drive unit 58, the third lens holding frame 32 moves in the optical axis direction together with the third group rack 33.

The front side housing member 50 and the rear side housing member 51 function as a housing of the lens barrel 100. Specifically, the front side housing member 50 and the rear side housing member 51 accommodate the first lens unit 10, the second lens unit 20, and the third lens unit 30 and protect each lens unit from an external shock. The front side housing member 50 and the rear side housing member 51 are fixed together with screws or the like. The guide bars 52, 53, 54, and 55 are supported by the front side housing member 50 and the rear side housing member 51. Further, the first group drive unit 56, the second group drive unit 57, and the third group drive unit 58 are fixed to the rear side housing member 51 with screws or the like.

The imaging element unit 300 includes an imaging element 301 and an imaging substrate 302. The imaging element 301 is mounted on the imaging substrate 302. The imaging substrate 302 is fixed to the rear side housing member 51 with screws or the like. The present exemplary embodiment is not limited to a form in which the imaging substrate 302 is fixed to the rear side housing member 51, and, for example, the imaging substrate 302 may be fixed to the rear side housing member 51 via another member.

According to the imaging apparatus 1 configured as described above, the first lens unit 10, the second lens unit 20, and the third lens unit 30 move in the optical axis direction of the imaging optical system while maintaining a predetermined positional relationship to perform zooming and focusing. Light collected by the first lens unit 10, the second lens unit 20, and the third lens unit 30 is focused on the imaging element 301, so that a desired image can be acquired.

Next, eccentricity adjustment in the second lens unit 20 is described. In a case where eccentricity adjustment is performed on the second lens unit 20, the second lens unit 20 is arranged so that the optical axis O is directed in a vertical direction, the second lens holding frame 22 is on a lower side, and the second adjustment frame 27 is on an upper side.

First, a method for adjusting the eccentricity of the first adjustment lens 24 and a method for fixing the first adjustment frame 26 are escribed.

FIG. 4 is a cross-sectional view of the second lens unit 20. A left side of FIG. 4 is a cross section passing through a first bonding portion 223 and a second bonding portion 263, which are described below. On the other hand, a right side of FIG. 4 is a cross section passing through a screw 233, which is described below.

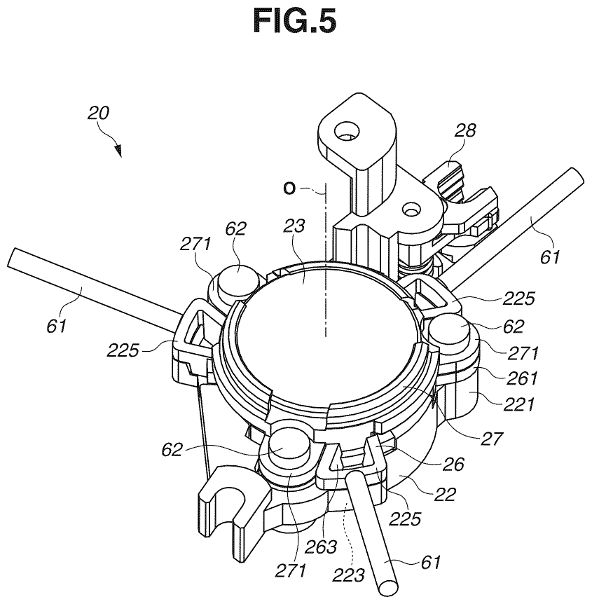

FIG. 5 is a perspective view illustrating a state in which eccentricity adjustment is performed on the first adjustment lens 24.

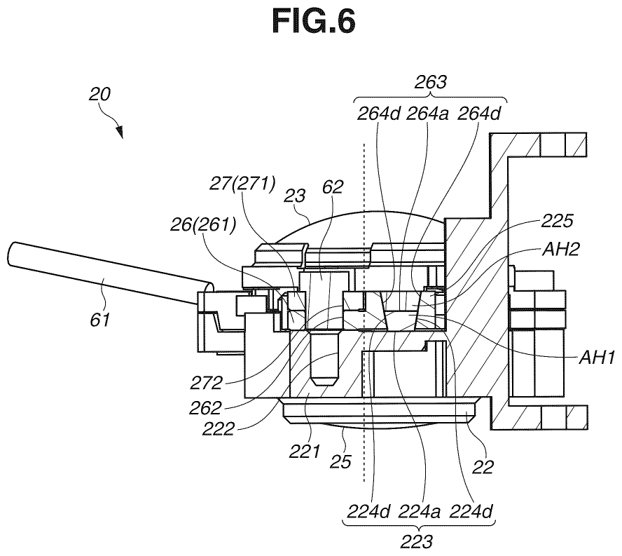

FIG. 6 is a cross-sectional view of the second lens unit 20. A left side of FIG. 6 is a cross section passing through a regulating member 62 that is arranged at a time of performing eccentricity adjustment on the first adjustment lens 24. On the other hand, a right side of FIG. 6 is a cross section of the first bonding portion 223 and the second bonding portion 263 after the eccentricity adjustment of the second adjustment lens 23 and after bonding.

In a case where the eccentricity adjustment is performed on the first adjustment lens 24, a side surface portion of the first adjustment frame 26 is pressed using a first adjustment jig 61 such as at least one pin. The first adjustment jig 61 may be configured to adsorb, for example, the first adjustment frame 26. FIG. 5 illustrates an example in which adjustment is performed by pressing an enclosure portion 225, which is described below, of the first adjustment frame 26 from three directions using the first adjustment jigs 61.

As the first adjustment jigs 61 move back and forth, the first adjustment frame 26 moves in the direction orthogonal to the optical axis with respect to the second lens holding frame 22. The first adjustment frame 26 that holds the first adjustment lens 24 moves, so that the first adjustment lens 24 is moved to a desired position and the eccentricity adjustment is performed.

It is desirable to perform the eccentricity adjustment on the first adjustment lens 24 to offset a sum of minute eccentric deviations of each lens in a state where the first lens unit 10 and the third lens unit 30 are arranged. The eccentricity adjustment may be performed so that the optical axis of the reference lens 25 held by the second lens holding frame 22 and the optical axis of the first adjustment lens 24 coincide with each other. In this case, the minute eccentric deviation of each lens can be offset in the second lens unit 20.

The second lens holding frame 22 has a fastening portion 221 that is formed close to an outer peripheral edge of the second lens holding frame 22. The fastening portion 221 extends in the optical axis direction and is formed with a female screw portion 222 into which the screw 233 as a fastening member is screwed. A plurality of the fastening portions 221 (three in this example) is arranged at approximately equal intervals on a circumference centered on the optical axis O.

The first adjustment frame 26 has a fastening portion 261 that is formed close to an outer peripheral edge of the first adjustment frame 26. The fastening portion 261 is an example of a first fixing portion and is a portion for fixing the first adjustment frame 26 to the second lens holding frame 22. The fastening portion 261 is formed with a through hole 262 through which the screw 233 is inserted in the optical axis direction. A plurality of the fastening portions 261 (three in this example) is arranged at approximately equal intervals on the circumference centered on the optical axis O.

The second adjustment frame 27 has a fastening portion 271 that is formed close to an outer peripheral edge of the second adjustment frame 27. The fastening portion 271 is an example of a second fixing portion and is a portion for fixing the second adjustment frame 27 to the first adjustment frame 26 or the second lens holding frame 22. The fastening portion 271 is formed with a through hole 272 through which the screw 233 is inserted in the optical axis direction. A plurality of the fastening portions 271 (three in this example) is arranged at approximately equal intervals on the circumference centered on the optical axis O.

The fastening portion 221 of the second lens holding frame 22, the fastening portion 261 of the first adjustment frame 26, and the fastening portion 271 of the second adjustment frame 27 are arranged to partially overlap each other when viewed from the optical axis direction. Further, the female screw portion 222 of the second lens holding frame 22, the through hole 262 of the first adjustment frame 26, and the through hole 272 of the second adjustment frame 27 communicate with each other in the optical axis direction. An inner diameter of the through hole 262 of the first adjustment frame 26 and an inner diameter of the through hole 272 of the second adjustment frame 27 are formed larger, to some extent, than an inner diameter of the female screw portion 222 of the second lens holding frame 22. Accordingly, even when the first adjustment frame 26 is moved in the direction orthogonal to the optical axis with respect to the second lens holding frame 22, the screw 233 can be fastened to the female screw portion 222 without interfering the through holes 262 and 272.

In a case where the eccentricity adjustment is performed on the first adjustment lens 24, the shaft-like regulating member 62 such as a pin is used to regulate a movement of the second adjustment frame 27 with respect to the first adjustment frame 26 so that the second adjustment frame 27 moves together with the first adjustment frame 26. The regulating member 62 is used as a jig. Specifically, in a case where the eccentricity adjustment is performed on the first adjustment lens 24, the screw 233 is not yet fastened, and the regulating member 62 is inserted into the through hole 272 of the second adjustment frame 27 and the through hole 262 of the first adjustment frame 26 as illustrated in FIG. 6. The regulating member 62 has a length that does not contact the female screw portion 222 while having a shaft diameter that engages with the through holes 272 and 262. In other words, the shaft diameter of the regulating member 62 is larger than a shaft diameter of the screw 233. As illustrated in FIG. 5, a plurality of the regulating members 62 is inserted into the through holes 272 and 262 respectively, so that the eccentricity adjustment can be performed on the first adjustment lens 24 in a state in which the optical axis of the first adjustment lens 24 and the optical axis of the second adjustment lens 23 substantially coincide with each other. The first adjustment lens 24 and the second adjustment lens 23 are each responsible for improving different optical performance, but if the second adjustment lens 23 moves freely during the eccentricity adjustment of the first adjustment lens 24, the deviation of the optical axis cannot be appropriately corrected. Thus, the second adjustment frame 27 moves together with the first adjustment frame 26, and accordingly high optical performance can be achieved. According to the present exemplary embodiment, the inner diameters of the through holes 272 and 262 are the same, but in a case where a stepped regulating member 62 is used, the inner diameter of the through hole 272 may be larger than the inner diameter of the through hole 262.

When the eccentricity adjustment of the first adjustment lens 24 is completed, the first adjustment frame 26 is fixed to the second lens holding frame 22. The first adjustment frame 26 is fixed to the second lens holding frame 22 using, for example, adhesion.

The second lens unit 20 has the first bonding portion 223 that is formed close to the outer peripheral edge of the first adjustment frame 26. The first bonding portion 223 is an example of the first fixing portion and is a portion for fixing the first adjustment frame 26 to the second lens holding frame 22. A plurality of the first bonding portions 223 (three in this example) is arranged at approximately equal intervals on the circumference centered on the optical axis O.

The first bonding portion 223 is configured by a part of the second lens holding frame 22 and a part of the first adjustment frame 26. As illustrated in FIGS. 4 and 6, the first bonding portion 223 is formed in a concave shape recessed toward the image side in the optical axis direction by a bottom surface 224a perpendicular to the optical axis O and side surfaces 224b, 224c (see FIGS. 4), and 224d (see FIG. 6) extending from the bottom surface 224a in the optical axis direction. According to the present exemplary embodiment, the bottom surface 224a is formed by a part of the second lens holding frame 22. Further, the side surface 224b is located away from the optical axis O and is configured by the second lens holding frame 22 extending from the bottom surface 224a towards the object side in the optical axis direction. The side surface 224c is located on the optical axis O side and is configured by a part of the first adjustment frame 26. Further, as illustrated in FIG. 6, a pair of facing side surfaces 224d are configured by the enclosure portion 225 that is integrally formed with the first adjustment frame 26 and has a substantially C-shape when viewed from the optical axis direction. In other words, of the side surfaces 224b to 224d of the first bonding portion 223 according to the present exemplary embodiment, the side surfaces other than the side surface 224b located away from the optical axis O side are formed by the first adjustment frame 26.

The first bonding portion 223 is filled with an adhesive (AH1), so that the first adjustment frame 26 is fixed to the second lens holding frame 22 via the adhesive (AH1). After the first adjustment frame 26 is fixed to the second lens holding frame 22, the first adjustment jig 61 and the regulating member 62 are removed, so that the eccentricity adjustment of the first adjustment lens 24 and fixing (temporary fixing) of the first adjustment frame 26 are completed.

Next, a method for adjusting the eccentricity of the second adjustment lens 23 and a method for fixing the second adjustment frame 27 are described.

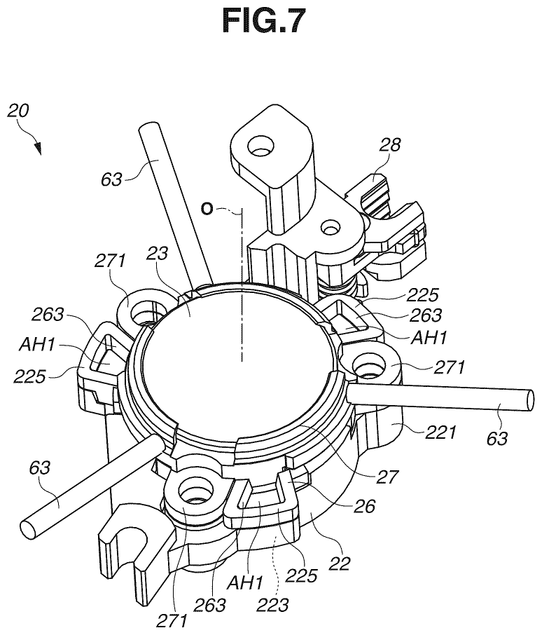

FIG. 7 is a perspective view illustrating a state in which eccentricity adjustment is performed on the second adjustment lens 23.

In a case where the eccentricity adjustment is performed on the second adjustment lens 23, a side surface portion of the second adjustment frame 2 is pressed using a second adjustment jig 63 such as at least one pin. The second adjustment jig 63 may be configured to absorb, for example, the second adjustment frame 27. FIG. 7 illustrates an example in which adjustment is performed by pressing an outer peripheral side surface of the second adjustment frame 27 from three directions using the second adjustments jigs 63.

As the second adjustment jigs 63 move back and forth, the second adjustment frame 27 moves in the direction orthogonal to the optical axis with respect to the second lens holding frame 22 and the first adjustment frame 26. The second adjustment frame 27 that holds the second adjustment lens 23 moves, so that the second adjustment lens 23 is moved to a desired position and the eccentricity adjustment is performed.

It is desirable to perform the eccentricity adjustment on the second adjustment lens 23 to offset a sum of the minute eccentric deviations of each lens in a state in which the first lens unit 10 and the third lens unit 30 are arranged. Since the eccentricity of the first adjustment lens 24 has already been adjusted, the eccentricity adjustment may be performed so that the optical axis of the second adjustment lens 23 coincides with that of the first adjustment lens 24 and the reference lens 25 the optical axes of which coincide with each other. In this case, the minute eccentric deviation of each lens can be offset within the second lens unit 20.

After the eccentricity adjustment of the second adjustment lens 23 is completed, the second adjustment frame 27 is fixed to the first adjustment frame 26. The second adjustment frame 27 is fixed to the first adjustment frame 26 using, for example, adhesion.

The second lens unit 20 has the second bonding portion 263 that is formed closed to the outer peripheral edge of the second adjustment frame 27. The second bonding portion 263 is an example of the second fixing portion and is a portion for fixing the second adjustment frame 27 to the second lens holding frame 22 or the first adjustment frame 26. A plurality of the second bonding portions 263 (three in this example) is arranged at approximately equal intervals on the circumference centered on the optical axis O. The second bonding portion 263 and the above-described first bonding portion 223 are arranged to partially overlap each other when viewed from the optical axis direction.

The first bonding portion 223 and the second bonding portion 263 are arranged so as not to overlap the above-described fastening portions 261, 271, and 221 respectively in phase on the circumference. Further, the first bonding portion 223 and the second bonding portion 263 are arranged adjacent to the fastening portions 261, 271, and 221 when viewed from the optical axis direction. Furthermore, the first bonding portion 223, the second bonding portion 263, the fastening portions 261, 271, and 221, and the guide bars 52, 53, 54, and 55 are arranged so as not to overlap each other when viewed from the optical axis direction.

The second bonding portion 263 is configured by a part of the adhesive (AH1) filled into the first bonding portion 223, a part of the second adjustment frame 27, and a part of the first adjustment frame 26. As illustrated in FIGS. 4 and 6, the second bonding portion 263 is formed in a concave shape recessed toward the image side in the optical axis direction by a bottom surface 264a perpendicular to the optical axis O and side surfaces 264b, 264c (see FIGS. 4), and 264d (see FIG. 6) extending from the bottom surface 264a in the optical axis direction. According to the present exemplary embodiment, the bottom surface 264a is configured by a part of the adhesive (AH1) filled into the first bonding portion 223. The side surface 264b is located away from the optical axis O and is configured by the enclosure portion 225 that is integrally formed with the first adjustment frame 26. Further, as illustrated in FIG. 6, a pair of facing side surfaces 264d is configured by the enclosure portion 225. The pair of side surfaces 264d is formed to extend continuously from the above-described pair of side surfaces 224d. Furthermore, the pair of side surfaces 264d and the pair of side surfaces 224d are integrally formed of the same member, specifically, the first adjustment frame 26. Thus, of the side surfaces 264b to 264d of the second bonding portion 263 according to the present exemplary embodiment, the side surfaces other than the side surface 264c located on the optical axis O side are formed by a part of the first adjustment frame 26.

The second bonding portion 263 is filled with an adhesive (AH2), so that the second adjustment frame 27 is fixed to the first adjustment frame 26 via the adhesive (AH2). After the second adjustment frame 27 is fixed to the first adjustment frame 26, the second adjustment jig 63 is removed, and the eccentricity adjustment of the first adjustment lens 24 and fixing (temporary fixing) of the first adjustment frame 26 are completed.

Finally, the first adjustment frame 26 and the second adjustment frame 27 are fixed to the second lens holding frame 22 using the screw 233 as a common fastening member. In other words, the screw 233 is inserted in the optical axis direction into the through hole 272 of the fastening portion 271 of the second adjustment frame 27 and the through hole 262 of the fastening portion 261 of the first adjustment frame 26. The screw 233 inserted into the through holes 272 and 262 is fastened from the object side to the female screw portion 222 of the fastening portion 221 of the second lens holding frame 22, so that the first adjustment frame 26 and the second adjustment frame 27 are fixed to the second lens holding frame 22. In this way, fastening with the screw 233 can prevent the first adjustment frame 26 or the second adjustment frame 27 from fluctuating due to expansion and contraction of the adhesive, and reliability of the optical performance can be improved.

As illustrated in FIG. 6, the side surface 264d of the second bonding portion 263 is formed by extending the side surface 224d of the first bonding portion 223 in the optical axis direction. In other words, the side surface 264d of the second bonding portion 263 and the side surface 224d of the first bonding portion 223 are a common continuous surface. With this configuration, the first bonding portion 223 and the second bonding portion 263 have a portion that completely overlaps each other when viewed from the optical axis direction, so that it is possible to reduce a space for a fixing structure.

In addition, in a case where low viscosity adhesive is filled, the side surface 264d of the second bonding portion 263 and the side surface 224d of the first bonding portion 223, which are continuous, act as a guide to allow the adhesive to be filled into the first bonding portion 223.

As described above, according to the present exemplary embodiment, the first adjustment frame 26 and the second adjustment frame 27 that can be adjusted in the direction orthogonal to the optical axis with respect to the second lens holding frame 22 are arranged on the object side of the optical axis direction with respect to the second lens holding frame 22. Various components for forming an image and driving the lenses are arranged on the image side in the optical axis direction. The first adjustment frame 26 and the second adjustment frame 27 are arranged on the object side, so that an adjustment mechanism and various components can be arranged to suppress interference with each other, thereby suppressing the lens units and the lens barrel from becoming larger.

Further, according to the present exemplary embodiment, the first bonding portion 223 and the second bonding portion 263 are arranged to partially overlap each other when viewed from the optical axis direction. Further, the fastening portions 261 and 271 are arranged to partially overlap each other when viewed from the optical axis direction. Thus, structures related to lens drive, such as a rack holding structure and a guide bar engagement structure, can be arranged in a space where the first bonding portion 223, the second bonding portion 263, the fastening portions 261 and 271 are not arranged, when viewed from the optical axis direction. Accordingly, compared with a case where a lens is held using a pressing ring or the like as in a conventional technique, the structures related to lens drive can be arranged near the optical axis O, thereby preventing the lens units and the lens barrel from becoming larger.

Further, according to the present exemplary embodiment, the first bonding portion 223 and the second bonding portion 263 are arranged to partially overlap each other when viewed from the optical axis direction. Thus, the first adjustment frame 26 and the second adjustment frame 27 can be bonded at substantially the same position in a direction perpendicular to the optical axis.

Further, according to the present exemplary embodiment, in a case where the second lens unit 20 is assembled, the second lens holding frame 22, the first adjustment frame 26, and the second adjustment frame 27 are arranged in this order from a lower side in the direction of gravity.

Thus, in a case where the first adjustment frame 26 and the second adjustment frame 27 are adjusted, bonded with the adhesive, and fastened with the screw 233 with respect to the second lens holding frame 22, the operation can be performed from above in the direction of gravity. Therefore, the configuration allows the first adjustment frame 26 and the second adjustment frame 27 to be easily adjusted and assembled.

Further, according to the present exemplary embodiment, in a case where the eccentricity adjustment is performed on the first adjustment lens 24, the regulating member 62 is inserted into the through hole 272 of the second adjustment frame 27 and the through hole 262 of the first adjustment frame 26, so that the second adjustment frame 27 can be moved together with the first adjustment frame 26. Furthermore, the through holes 262 and 272 into which the regulating member 62 is inserted also serve as holes for fastening the second adjustment frame 27 and the first adjustment frame 26 to the second lens holding frame 22. Thus, there is no need to provide a new structure for inserting the regulating member 62, and it is possible to reduce a space for the second lens unit 20. In a case where a new structure is provided to insert the regulating member 62, a configuration for blocking the hole penetrating through the first adjustment frame 26 and the second adjustment frame 27 to prevent stray light is necessary, but the present exemplary embodiment also eliminates the need to prevent stray light.

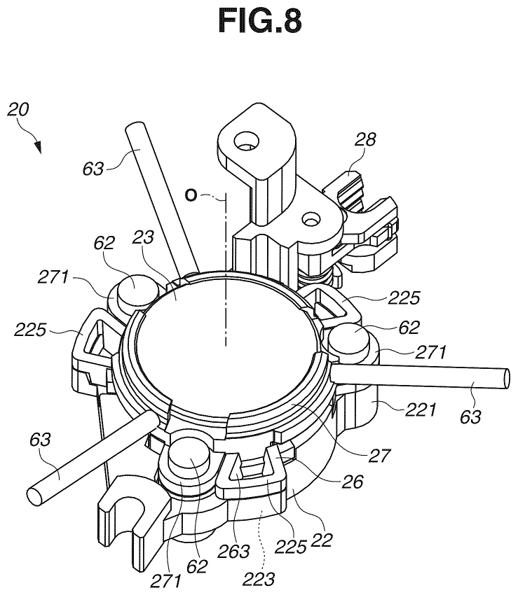

FIG. 8 is a perspective view illustrating a state in which eccentricity adjustment is performed on the first adjustment lens 24 according to a first modification. According to the present modification, in a case where the eccentricity adjustment is performed on the first adjustment lens 24, the second adjustment jig 63 is used instead of the first adjustment jig 61 to press the outer peripheral side surface of the second adjustment frame 27 for adjustment. If the regulating member 62 is used, the first adjustment frame 26 can be moved together with a movement of the second adjustment frame 27, so that the second adjustment jig 63 may be moved back and forth to adjust the first adjustment frame 26 and to move the second adjustment frame 27 in the direction orthogonal to the optical axis.

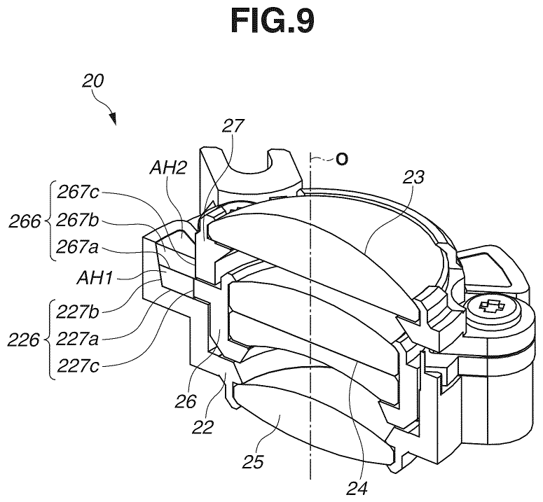

FIG. 9 is a cross-sectional perspective view illustrating configurations of a first bonding portion 226 and a second bonding portion 266 according to a second modification.

The first bonding portion 226 is formed in a concave shape recessed toward the image side in the optical axis direction by a bottom surface 227a perpendicular to the optical axis O and side surfaces 227b and 227c extending in the optical axis direction from the bottom surface 227a. The bottom surface 227a is configured by a part of the second lens holding frame 22. The side surface 227b located away from the optical axis O is configured by a part of the second lens holding frame 22, and the side surface 227c on the optical axis O side is configured by a part of the first adjustment frame 26. Further, a pair of side surfaces, which are not illustrated, is configured by a part of the second lens holding frame 22. Thus, the side surfaces other than the side surface 227c on the optical axis O side are configured by a part of the second lens holding frame 22.

The second bonding portion 266 is formed in a concave shape recessed toward the image side in the optical axis direction by a bottom surface 267a perpendicular to the optical axis O and side surfaces 267b and 267c extending in the optical axis direction from the bottom surface 267a. The bottom surface 267a is configured by a part of the adhesive (AH1) filled into the first bonding portion 226. The side surface 267b located away from the optical axis O is configured by a part of the second lens holding frame 22, and the side surface 267c on the optical axis O side is configured by a part of the second adjustment frame 27. Further, a pair of side surfaces, which are not illustrated, is configured by a part of the second lens holding frame 22. Thus, the side surfaces other than the side surface 227c are configured by a part of the second lens holding frame 22.

According to the present modification, the side surfaces of the second bonding portion 266 other than the side surface 267c are formed to extend continuously from the side surfaces of the first bonding portion 226 other than the side surface 227c. Further, the side surfaces of the second bonding portion 266 other than the side surface 267c and the side surfaces of the first bonding portion 226 other than the side surface 227c are integrally formed of the same member, specifically, the second lens holding frame 22. Thus, the first bonding portion 226 and the second bonding portion 266 can be bonded to a common surface, and accordingly the same effect as in the first exemplary embodiment can be achieved.

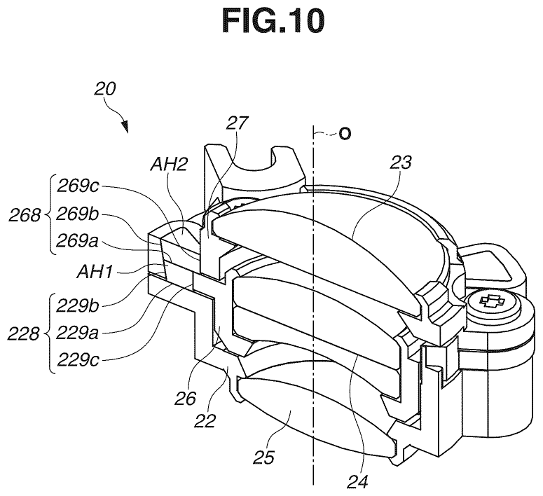

FIG. 10 is a cross-sectional perspective view illustrating configurations of a first bonding portion 228 and a second bonding portion 268 according to a third modification.

The first bonding portion 228 is formed in a concave shape recessed toward the image side in the optical axis direction by a bottom surface 229a perpendicular to the optical axis O and side surfaces 229b and 229c extending in the optical axis direction from the bottom surface 229a. The bottom surface 229a is configured by a part of the second lens holding frame 22. The side surfaces 229b and 229c and a pair of side surfaces, which are not illustrated, are formed by a part of the first adjustment frame 26.

The second bonding portion 268 is formed in a concave shape recessed toward the image side in the optical axis direction by a bottom surface 269a perpendicular to the optical axis O and side surfaces 269b and 269c extending in the optical axis direction from the bottom surface 269a. The bottom surface 269a is configured by a part of the adhesive (AH1) filled into the first bonding portion 228. The side surface 269c on the optical axis O side is configured by a part of the second adjustment frame 27, and the side surfaces other than the side surface 269c on the optical axis O side are configured by a part of the first adjustment frame 26.

According to the present modification, the side surfaces of the second bonding portion 268 other than the side surface 269c are formed to extend continuously from the side surfaces of the first bonding portion 228 other than the side surface 229c. Further, the side surfaces of the second bonding portion 268 other than the side surface 269c and the side surfaces of the first bonding portion 228 other than the side surface 229c are integrally formed of the same member, specifically, the first adjustment frame 26. Thus, the first bonding portion 228 and the second bonding portion 268 can be bonded to a common surface, and accordingly the same effect as in the first exemplary embodiment can be achieved.

The desirable exemplary embodiments of the present disclosure are described above, but the invention is not limited to these exemplary embodiments, and various modifications and variations are possible within the scope of the gist of the present disclosure. Further, there are no limitations as long as the configuration takes into consideration the design function.

According to the above-described exemplary embodiments, the case is described in which the first adjustment frame 26 is fixed to the second lens holding frame 22 via the adhesive and the second adjustment frame 27 is fixed to the first adjustment frame 26 or the second lens holding frame 22 via the adhesive. However, the invention is not limited to this case. For example, the first adjustment frame 26 and the second adjustment frame 27 may be fixed collectively to the second lens holding frame 22 using the screw 233 as a fastening member. In this case, after the eccentricity adjustment is performed on the first adjustment lens 24, the eccentricity adjustment is performed on the second adjustment lens 23 without removing the first adjustment jig 61, and the screw 233 is fastened to the fastening portion 221 of the second lens holding frame 22. After the screw 233 is fastened, the first adjustment jig 61 and the second adjustment jig 63 are removed. Further, the first adjustment frame 26 and the second adjustment frame 27 may be fixed to the second lens holding frame 22 using only the adhesive without fastening the screw 233.

According to the above-described exemplary embodiments, the female screw portion 222 is not limited to a case where a screw is formed in advance, but may be formed by screwing the screw 233 thereinto. Further, the fastening member is not limited to the screw 233, but may be a rivet, or the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-207118, filed Dec. 7, 2023, which is hereby incorporated by reference herein in its entirety.

What is claimed is:

1. A lens unit that includes a plurality of lenses, the lens unit comprising:
a holding frame configured to hold a first lens of the plurality of lenses;
a first adjustment frame configured to hold a first adjustment lens of the plurality of lenses and adjust the first adjustment lens in a direction orthogonal to an optical axis with respect to the holding frame; and
a second adjustment frame configured to hold a second adjustment lens of the plurality of lenses and adjust the second adjustment lens in the direction orthogonal to the optical axis with respect to the holding frame,
wherein the first adjustment frame and the second adjustment frame are arranged on an object side in an optical axis direction with respect to the holding frame.

2. The lens unit according to claim 1, further comprising:
a first fixing portion configured to fix the first adjustment frame to the holding frame; and
a second fixing portion configured to fix the second adjustment frame to the holding frame or the first adjustment frame.

3. The lens unit according to claim 2, wherein the first fixing portion and the second fixing portion at least partially overlap each other when viewed from the optical axis direction.

4. The lens unit according to claim 2, wherein the first fixing portion and the second fixing portion are each filled with an adhesive.

5. The lens unit according to claim 4,
wherein the first fixing portion and the second fixing portion are each formed in a concave shape recessed toward an image side in the optical axis direction, and
wherein a part of a side surface of the first fixing portion and a part of a side surface of the second fixing portion are continuous and integrally formed.

6. The lens unit according to claim 4,
wherein the first fixing portion and the second fixing portion are each formed in a concave shape recessed toward an image side in the optical axis direction, and
wherein a bottom surface of the second fixing portion is configured by the adhesive filled in the first fixing portion.

7. The lens unit according to claim 2,
wherein the first fixing portion and the second fixing portion have a through hole through which a fastening member is inserted in the optical axis direction, and
wherein the holding frame is fastened with the fastening member that is inserted into the through hole of the first fixing portion and the through hole of the second fixing portion.

8. The lens unit according to claim 7, wherein an inner diameter of the through hole of the second fixing portion is a same as or larger than an inner diameter of the through hole of the first fixing portion.

9. The lens unit according to claim 1, further comprising:
a first bonding portion configured to bond the first adjustment frame to the holding frame using an adhesive;
a second bonding portion configured to bond the second adjustment frame to the holding frame or the first adjustment frame using an adhesive;
a first fastening portion configured to fasten the first adjustment frame to the holding frame using a fastening member; and
a second fastening portion configured to fasten the second adjustment frame to the holding frame or the first adjustment frame using the fastening member.

10. The lens unit according to claim 9,
wherein the first bonding portion and the second bonding portion at least partially overlap each other when viewed from the optical axis direction,
wherein the first fastening portion and the second fastening portion at least partially overlap each other when viewed from the optical axis direction, and
wherein the first bonding portion and the second bonding portion, and the first fastening portion and the second fastening portion are arranged adjacent to each other when viewed from the optical axis direction.

11. The lens unit according to claim 1, wherein the holding frame moves in the optical axis direction by a guide bar.

12. A lens barrel comprising:
a lens unit including:
a holding frame configured to hold a first lens of the plurality of lenses;
a first adjustment frame configured to hold a first adjustment lens of the plurality of lenses and adjust the first adjustment lens in a direction orthogonal to an optical axis with respect to the holding frame;
a second adjustment frame configured to hold a second adjustment lens of the plurality of lenses and adjust the second adjustment lens in the direction orthogonal to the optical axis with respect to the holding frame;
a first fixing portion configured to fix the first adjustment frame to the holding frame; and
a second fixing portion configured to fix the second adjustment frame to the holding frame or the first adjustment frame; and
a plurality of guide bars configured to engage with the holding frame,
wherein the first adjustment frame and the second adjustment frame are arranged on an object side in an optical axis direction with respect to the holding frame, and
wherein the plurality of guide bars, the first fixing portion, and the second fixing portion are arranged not to overlap each other when viewed from the optical axis direction.

13. A method for adjusting a lens unit that includes a plurality of lenses,
wherein the lens unit includes:
a holding frame configured to hold a first lens of the plurality of lenses;
a first adjustment frame configured to hold a first adjustment lens of the plurality of lenses and adjust the first adjustment lens in a direction orthogonal to an optical axis with respect to the holding frame; and
a second adjustment frame configured to hold a second adjustment lens of the plurality of lenses and adjust the second adjustment lens in the direction orthogonal to the optical axis with respect to the holding frame, and
wherein the first adjustment frame and the second adjustment frame are arranged on an object side in an optical axis direction with respect to the holding frame,
the method comprising adjusting the first adjustment frame in the direction orthogonal to the optical axis with respect to the holding frame in a state in which a movement of the second adjustment frame with respect to the first adjustment frame is restricted.

14. The method according to claim 13,
wherein the first adjustment frame includes a first fastening portion configured to fasten the first adjustment frame to the holding frame, and
wherein the second adjustment frame includes a second fastening portion configured to fasten the second adjustment frame to the holding frame or the first adjustment frame,
the method further comprising inserting a regulating member into a through hole of the first fastening portion and a through hole of the second fastening portion to restrict a movement of the second adjustment frame with respect to the first adjustment frame.

15. The method according to claim 14, further comprising inserting a fastening member having a shaft diameter smaller than a shaft diameter of the regulating member into the through hole of the first fastening portion and the through hole of the second fastening portion, thereby fastening the fastening member to the holding frame.
